(19) United States
(12) Patent Application Publication
(10) Pub. No.: US 2025/0108356 A1
(43) Pub. Date: Apr. 3, 2025

(54) All-in-on Getters

(71) Applicants: Hua Xia, Huffman, TX (US); David DeWire, Superior, CO (US); Tian Xia, Lorton, VA (US)

(72) Inventors: Hua Xia, Huffman, TX (US); David DeWire, Superior, CO (US); Tian Xia, Lorton, VA (US)

(21) Appl. No.: 18/977,893

(22) Filed: Dec. 11, 2024

(51) Int. Cl. B01J 20/28; B01D 53/02; B01J 20/02; B01J 20/04; B01J 20/06; B01J 20/08; B01J 20/18; B01J 20/26; B33Y 30/00; B33Y 80/00

(52) U.S. Cl. CPC B01J 20/28026; B01D 53/02; B01J 20/0233; B01J 20/041; B01J 20/06; B01J 20/08; B01J 20/18; B01J 20/262; B01J 20/2808; B01J 20/28083; B01J 20/28085; B33Y 30/00; B33Y 80/00; B01D 2253/104; B01D 2253/108; B01D 2253/1124; B01D 2253/202; B01D 2253/25; B01D 2253/308; B01D 2257/102; B01D 2257/104; B01D 2257/108; B01D 2257/302; B01D 2257/406; B01D 2257/502; B01D 2257/504; B01D 2257/7025; B01D 2257/7027; B01D 2257/708; B01D 2257/80; B01D 2257/91

(57) ABSTRACT

This invention reveals functional particle co-embedded multi-phase hierarchical porous nanostructured polymer composites, along with all-in-one getter assemblies tailored to manage particulate and gaseous emissions, particularly from microelectronic and electronic packages, as well as various industrial systems. The getter assemblies, available in single-layered, bilayered, and multilayered configurations, offer customized solutions to address specific emission control challenges in diverse environments.

### FIELD OF THE INVENTION

This invention pertains to all-in-one getter assemblies specifically designed to capture a broad spectrum of particles and gases emitted from electronic packages, devices, and modules. More particularly, it relates to functional particle co-embedded, multi-phase hierarchical composite getters with precisely tailored surface energy properties for particulate emission and gaseous emission control and management.

### BACKGROUND

Packaging materials commonly used in electronic devices—such as polymers, epoxies, adhesives, metals, ceramics, and glasses—can release various particles, gases, and organic compounds throughout their operational lifecycle. These emissions result from factors such as environmental exposure, thermal cycling, outgassing, and mechanical wear. Gaseous and organic emissions typically include both polar and non-polar molecules, often originating from the decomposition of adhesives, coatings, or other organic components. In contrast, particulate emission arises from wear and tear, chemical reactions, or the condensation of outgassed molecules into solid matter. These particles include electrically charged particles, magnetic particles, dielectric particles, fine dust, and microbial contaminants. Gaseous emissions can lead to corrosion, contamination, and degradation of sensitive components, while particulate emission may cause physical obstructions, short circuits, or interference with devices like microelectromechanical systems (MEMS) and photoelectric modules. Such emissions present unique challenges for hermetically sealed electronic packages, which require robust mitigation strategies.

The particles emitted within electronic packages vary widely in type and origin. Particulate matter often forms through the condensation of outgassed gases and organic compounds, either floating within the package's internal headspace or settling on component surfaces. Electrically charged particles or “electric particles” may result from static discharge, ionization, or degradation of packaging materials. Magnetic particles, typically ferromagnetic or paramagnetic, originate from wear, corrosion, or the breakdowns of metallic components such as nickel or cobalt alloys or from magnetic fillers in composite materials, potentially interfering with magnetic or inductive components. Dielectric particles, which are electrically insulating, often come from the degradation of dielectric materials such as polymers, ceramics, or low-polarity coatings. Fine dust, comprising materials like silica, polymer fragments, or inorganic debris, can arise from the breakdown of adhesives, encapsulants, or conformal coatings. These particles can contaminate optical components, interfere with MEMS devices, or reduce thermal dissipation, thereby compromising system reliability.

Existing getter technologies face significant limitations in addressing these diverse emissions. For example, zeolite-based getters are primarily effective for moisture absorption, while Non-Evaporable Getters (NEGs) are designed to target specific gases such as hydrogen or carbon dioxide. However, these technologies fail to capture a wide range of contaminants, including organic compounds, dielectric particles, fine dust, and electrically or magnetically active particles. Zeolites, for instance, exhibit negligible adsorption capacity for particulate matter, while NEGs, though effective for hydrogen, CO₂, or O₂, are not suitable for particulate capture. Consequently, these technologies are insufficient for managing the wide spectrum of emissions present in sealed electronic packages, where accumulated contaminants—both particles and gases—can lead to voltage fluctuations, frequency instability, leakage currents, corrosion, and reduced thermal dissipation. Currently, no single getter technology comprehensively addresses all emission types, leaving electronic devices vulnerable to contamination.

This invention tackles these challenges by presenting multi-phase hierarchical porous nanostructured composites with co-embedded functional particles as an all-in-one getter solution. These polymer composites integrate electric, magnetic, and dielectric trapping particles, along with microporous, mesoporous, and macroporous nanoparticles, within a polymer matrix. This design facilitates the simultaneous capture of various particles and the adsorption of different gases and organic compounds. The getters can be customized to target specific contaminants, whether polar or non-polar gases or organic compounds, providing a promising method to enhance the reliability of diverse microelectronic and electronic packages, devices, and modules.

### SUMMARY OF THE INVENTION

In this disclosure, terms such as “the invention” and “present invention” refer to all subject matter described herein and in the claims. Similarly, “polymer composite” and “gettering material” are used interchangeably, as are “getter assembly” and “getter” The term “organic compounds” includes both polar and non-polar hydrocarbons (HCs) and volatile organic compounds (VOCs). The phrases “gaseous emission” and “polar gases and organic compounds, and non-polar gases and organic compounds” are used synonymously, as are “particle emissions” and “particulate emissions” despite slight differences in definition. These terms are intended for clarity and should not be interpreted as limiting the scope of the subject matter or claims.

The claims define the embodiments of the invention, not this summary, which offers a high-level introduction to key concepts further elaborated in the Detailed Description. This summary is not intended to identify required or essential features of the claims and should not be used in isolation to determine their scope. The full scope of the subject matter should be understood by reviewing the entire specification, including all drawings and claims.

This invention introduces a getter specifically designed to manage a wide range of emissions commonly found in hermetically sealed microelectronic and electronic packages. The all-in-one getter assembly utilizes a functional particle co-embedded hierarchical porous nanostructured polymer composite to capture both particulate and gaseous emissions.

In one embodiment: The assembly consists of a functional particle co-embedded hierarchical porous nanostructured polymer composite.
In one aspect: at least a single type of functional particle is embedded within a polymer matrix on a substrate, with a hierarchical porous nanostructured polymer composite forming the outer layer.
In another aspect: at least two types of functional particles are simultaneously embedded in a polymer matrix on a substrate, integrated with a hierarchical porous nanostructured polymer composite outer layer.
In a further aspect: The getter assembly includes at least three types of functional particles co-embedded in a polymer matrix on a substrate, all encased within a hierarchical porous nanostructured polymer composite outer layer.

In an alternative embodiment, an all-in-one getter assembly is designed to capture both particle and gaseous emissions from a hermetically sealed package. This assembly addresses emissions such as electrically charged particles, magnetic particles, dielectric particles, fine dust, and microbial contaminants (which may originate from packaging materials), as well as polar gases, non-polar gases, polar organic compounds, and non-polar organic compounds. The highly hierarchical porous nanostructures of the polymer composite allow for effective separation and capture of particles and adsorption of gases using single-layer, bilayer, or multilayered structures.
In one aspect, the getter assembly is specifically functionalized to capture particles without gas adsorption, focusing on electric, magnetic, dielectric, fine dust, and microbial contaminants.
In another aspect: It is tailored for particle capture along with adsorption of polar gases and polar organic compounds.
In yet another aspect: The getter assembly can be functionalized to capture particles and adsorb non-polar gases and non-polar organic compounds.
In a further aspect: The getter assembly integrates function particles to capture particles and adsorb both hybrid polar and non-polar gases and organic compounds.

In a further embodiment, the all-in-one getter assembly includes a highly hierarchical porous nanostructured composite.
In one configuration: The assembly contains hydrophilic microporous, hydrophilic mesoporous, and hydrophilic macroporous nanomaterials designed to adsorb emissions of polar gas and organic compounds with high surface energy (>50 mJ/m²) and pore sizes of 0.3 nm-300 nm.
In another configuration: The getter assembly includes hydrophobic microporous, hydrophobic mesoporous, and hydrophobic macroporous materials for capturing emissions of non-polar gas and organic compounds with low surface energy (<30 mJ/m²) and pore sizes of 0.3 nm-300 nm.
In a further configuration: The getter assembly combines hybrid hydrophilic and hydrophobic mixed materials, with surface energy ranging from 20 to 80 mJ/m² and pore sizes of 0.3 nm-300 nm, to ensure balanced adsorption of gases regardless of their polarity, molecular size, or surface energy characteristics.

In yet another embodiment, the all-in-one getter assembly includes a highly hierarchical porous nanostructured composite.
In one aspect: The getter assembly contains microporous nanoparticles designed to adsorb emissions of small polar gas and organic compounds with high surface energy (>50 mJ/m²) and pore sizes of 0.3 nm-1.0 nm.
In another aspect: The getter assembly includes mesoporous nanoparticles for capturing emissions of medium-size non-polar gas and organic compounds with low surface energy (<30 mJ/m²) and pore sizes of 1 nm-50 nm.
In a further aspect: The getter assembly combines mixed microporous, mesoporous, and macroporous nanomaterials, with surface energy ranging from 20 to 80 mJ/m² and pore sizes of 50 nm-300 nm, to ensure adsorption of particle and gases and organic compounds with wide available nanoporous sizes.

In an alternative embodiment, the functional particle co-embedded hierarchical porous nanostructured composite is composed of the following key components:
Microporous nanomaterials with hydrophilic or hydrophobic properties, featuring a pore size of ≤1 nm.
Mesoporous and macroporous nanomaterials with hydrophilic or hydrophobic properties, featuring a pore size ranging from >1 nm to 300 nm.
Functional particles with hydrophilic or hydrophobic properties, specifically designed for particle adsorption, ranging in size from 100 nm to a few micrometers.
Polymer matrices with hydrophilic or hydrophobic properties, provided to ensure structural stability and flexibility.

In this context, hydrophobicity refers to low-surface-energy characteristics, while hydrophilicity denotes high-surface-energy characteristics. The hierarchical porous architecture integrates microporous, mesoporous, and macroporous nanomaterials with functional particles into a polymer matrix, resulting in a polymer composite with multi-level porosities. This design maximizes the active surface area and the density of adsorption sites, enabling the composite to effectively capture both particulate and gaseous emissions.

In another embodiment, the composites are engineered to exhibit varying surface energy properties for the efficient capture of a broad spectrum of particulate and gaseous emissions. This customization is achieved by selecting nanomaterials with specific hydrophilic or hydrophobic characteristics and configuring them as follows:
Low-surface-energy composite:
Composed of hydrophobic microporous, mesoporous, and macroporous nanomaterials co-embedded in a hydrophobic polymer matrix. This configuration is optimized to capture low-surface-energy particles, such as dielectric particles and fine dust, and to adsorb non-polar gases and non-polar organic compounds.
High-surface-energy composite:
Features hydrophilic microporous, mesoporous, and macroporous nanomaterials co-embedded in a hydrophilic polymer matrix. This setup excels at capturing high-surface-energy particles, such as electrically charged particles and certain magnetic particles, and adsorbing polar gases and polar organic compounds.
Medium-surface-energy composite:
Combines both hydrophilic and hydrophobic microporous, mesoporous, and macroporous nanomaterials co-embedded in either a hydrophilic or hydrophobic polymer matrix. This configuration captures medium-surface-energy particles, such as some magnetic particles and fine dust, and adsorbs a mixture of polar and non-polar gases and organic compounds.
Functional particle-enhanced composite:
Incorporates specialized functional particles (e.g., electric, magnetic, dielectric, and microbial particles) tailored for capturing specific particulate emissions. This configuration targets diverse particle types, including electrically charged particles, magnetic particles, dielectric particles, fine dust, and microbial contaminants for comprehensive emissions management.

These configurations aim to address the diverse emissions challenges in hermetically sealed microelectronic and electronic packages, as well as in various industrial systems and analytical instruments.

In another embodiment, the hierarchical porous nanostructured polymer composite is a multi-phase nanomaterial designed to capture a wide range of particles and gases. The composite includes the following phases:

First Phase—Microporous Nanomaterials: This phase consists of microporous nanomaterials with a range of surface energies and small pore sizes, optimized for adsorbing molecules based on their polarity and size.
Hydrophilic Microporous Nanomaterials: Selected from 3A, 4A, 5A, 13X zeolites, zeolite X, zeolite A, and natural zeolites. These materials have high surface energies (50-70 mJ/m²) and pore sizes (0.3-1.0 nm), making them highly effective for adsorbing polar molecules, such as water.
Hydrophobic Microporous Nanomaterials: Selected from silicalite-1, silicalite-2, ZSM-5, Beta-zeolite, and zeolite Y. These materials exhibit low-to-medium surface energies (25-50 mJ/m²) and pore sizes (0.3-1.0 nm), optimizing them for adsorbing non-polar molecules and organic compounds.

Second Phase—Mesoporous Nanoparticles: This phase provides a broader range of pore sizes and surface energy characteristics for capturing molecules and particles of various sizes.
Hydrophilic Mesoporous Nanomaterials: Selected from silica aerogel, SBA-15, MCM-41, and alumina aerogel. These materials exhibit high surface energies (50-80 mJ/m²) and 1-50 nm pore sizes, making them effective for adsorbing medium-sized polar molecules and organic compounds.
Hydrophobic Mesoporous Nanomaterials: Selected from silica aerogel, fluorosilica aerogel, alkylsilica aerogels, polymeric silica aerogels, and organosilica materials. These materials have low surface energies (5-30 mJ/m²) and 1-50 nm pore sizes, making them effective for adsorbing medium-sized non-polar molecules and organic compounds.

This phase ensures that the polymer composite captures particles and gases with sizes ranging from <1 nm up to 300 nm.

Third Phase—Macroporous Nanoparticles: This phase provides a broader range of pore sizes and surface energy characteristics for capturing molecules and particles of various sizes.
Hydrophilic Macroporous Nanomaterials: Selected from macroporous silica, alumina, ceramics, and macroporous zeolites. These materials exhibit medium-to-high surface energies (30-70 mJ/m²) and up to 300 nm pore sizes, enabling the capture of larger polar molecules and particles.
Hydrophobic Macroporous Nanomaterials: Selected from silica aerogel, fluorosilica aerogel, alkylsilica aerogels, polymeric silica aerogels, and organosilica materials. These materials have surface energies ranging from 30-80 mJ/m² and up to 300 nm pore sizes, suitable for trapping larger non-polar molecules and particulates.

This phase ensures that the polymer composite captures particles and gases with sizes ranging from <1 nm up to 300 nm.

Fourth Phase—Functional Particles: This phase incorporates specialized functional particles designed to effectively capture specific emissions:
Electric Particle Capture: Functional particles such as barium titanate (BaTiO₃), silver (Ag), and copper oxide (CuO) are embedded in a polymer matrix with medium-to-high surface energies (30-70 mJ/m²). These particles, typically less than 100 nm in size, include fine conductive materials like carbon nanotubes, metal oxides, or conductive polymers.
Magnetic Particle Capture: Materials such as iron oxides (Fe₂O₃, Fe₃O₄), cobalt ferrite (CoFe₂O₄), and nickel oxide (NiO) are embedded in a hydrophobic polymer matrix with low-to-medium surface energies (15-40 mJ/m²). These particles, generally less than 100 nm in size, include magnetic nanoparticles like Fe₃O₄ or γ-Fe₂O₃, often resulting from wear or contamination.
Dielectric Particle Capture: Dielectric particles such as alumina (α-Al₂O₃), silica (SiO₂), zirconia (ZrO₂), titanium dioxide (TiO₂), zinc oxide (ZnO), and silicon carbide (SiC) are embedded in a polymer matrix with medium surface energies (30-50 mJ/m²). These ceramic particles, typically less than 100 nm in size, include materials like BaTiO₃ or SiO₂, commonly used in capacitors.
Microbial Contaminant Capture: Emitted through environmental exposure, human handling, or manufacturing processes, microbial contaminants can be mitigated using materials such as Ag, TiO₂, ZrO₂, Au, and CuO. These are embedded in a polymer matrix with medium-to-high surface energies (30-70 mJ/m²) and particle sizes ranging from 20 nm to 10 μm, effectively addressing contamination concerns.

Final Phase—Polymer Matrix: The polymer matrix is crucial for embedding various nanoparticles and functional particles for getter functions and reliabilities. This phase includes:
Hydrophilic Polymers: Selected from polyvinyl alcohol (PVA) (35-55 mJ/m²), epoxy resin (40-50 mJ/m²), and polycarbonate (PC) (40-50 mJ/m²).
Hydrophobic Polymers: Selected from silicone RTV (20-25 mJ/m²) and polytetrafluoroethylene (PTFE) (18-30 mJ/m²).
Medium-Surface-Energy Polymers: Selected from polyimide (PI) (35-40 mJ/m²).

The choice of polymer ensures compatibility with the embedded nanoparticles, maintaining consistent performance under varying conditions of humidity, temperature, and pressure.

Surface energy modification for optimal integration. To achieve a high-quality composite material, it may be necessary to modify the surface energy of functional particles. Effective embedding of functional particles into a polymer matrix depends on the alignment of their surface energies. Ideally, the surface energy of the polymer should match or slightly exceed that of the particles to ensure proper wetting, adhesion, and dispersion. When surface energy mismatches occur:
Hydrophilic particles can be coated with hydrophobic materials (e.g., silanes) to improve compatibility with low-energy polymer matrices.
Hydrophobic particles can be functionalized with hydroxyl or carboxyl groups to enhance compatibility with high-energy hydrophilic polymers.
For extreme mismatches, interfacial modifiers, surfactants, or coupling agents (e.g., silanes, titanates) can be used to optimize adhesion and fine-tune surface energy levels.

For optimal composite performance, the surface energy of the polymer matrix and the embedded particles should ideally differ by no more than ±20 mJ/m².

Fabrication of functional particle co-embedded hierarchical porous nanostructured polymer composites. The fabrication process involves the following steps:
Preparation of nanoparticle suspension: Hydrophilic microporous nanoparticles, hydrophobic microporous nanoparticles, hydrophobic mesoporous, and macroporous particles are dispersed into a compatible polymer matrix (e.g., PVA, silicone RTV, epoxy resin, PI, PC, or PTFE). Solvents and dispersants are used to prevent agglomeration.
Application to substrates: The uniform nanoparticle-polymer suspension is applied to substrates such as copper, aluminum, titanium, or ceramics using advanced techniques like 3D layer-by-layer printing. This method allows precise control over the getter film thickness.
Post-fabrication treatments:
Low-heat drying: Removes residual solvents to ensure a stable composite structure.
Elevated-temperature curing: Enhances mechanical properties and ensures strong adhesion.
Optional hydrophobic surface modifications: Additional hydrophilic or hydrophobic nanoparticle-polymer layers can be applied to optimize the composite's surface affinity for specific particles and gases. Polar gases and particles exhibit a strong preference for hydrophilic getter surfaces, whereas non-polar gases, dielectric particles, and fine dust are better captured by hydrophobic getter surfaces.

The primary objective of this invention is to develop a versatile getter material capable of efficiently capturing both particulate and gaseous emissions, accommodating a variety of particle and gas types. This invention aims to provide a comprehensive solution for emission management across a wide range of industries, including the microelectronic and electronic sectors.

The secondary objective is to design a nanostructured composite material that serves as a universal gettering solution. This material can be customized to meet diverse emission control requirements, allowing for configurations such as single-layer, bilayer, or multilayer getter structures.

This summary outlines the invention's design principles, material selection, and fabrication methods for all-in-one getters, along with its primary and secondary objectives. Comprehensive details are provided in the complete disclosure, including supporting figures and claims.

### BRIEF DESCRIPTION OF THE DRAWINGS

The aspects of this disclosure are best understood through the detailed descriptions provided in conjunction with the accompanying figures. These descriptions and illustrations are intended to clarify the invention without imposing limitations. While specific details are included to ensure a comprehensive understanding, some well-known information may be omitted to maintain clarity. Furthermore, various modifications to the getter design can be implemented without departing from the scope of the disclosed embodiments. The following figures are provided for illustration:

FIG. 1: Cross-sectional views of various embodiments of an all-in-one getter with single-layered structure applied to a substrate, as described in the invention.

FIG. 2: Cross-sectional views of various embodiments of an all-in-one getter with bilayered structure applied to a substrate, as described in the invention.

FIG. 3: Cross-sectional views of various embodiments of an all-in-one getter with multilayered structure applied to a substrate, as described in the invention.

FIG. 4: Total adsorption capacity of particle and gaseous emissions for an all-in-one getter with single-layered structure, as described in the invention.

FIG. 5: Total adsorption capacity of particles and gaseous emissions for an all-in-one getter with bilayered structure, as described in the invention.

FIG. 6: Total adsorption capacity of particles and gaseous emissions for an all-in-one getter with multilayered structure, as detailed herein.

FIG. 7: Total adsorption capacity for particles, polar gases, and polar organic compounds emissions using an all-in-one getter with single-layered structure, as detailed herein.

FIG. 8: Total adsorption capacity for particles, non-polar gases, and non-polar organic compounds emissions using an all-in-one getter with single-layered structure, as detailed herein.

FIG. 9: Total adsorption capacity for particles and polar gaseous emissions using an all-in-one getter with single-layered structure, as detailed herein.

FIG. 10: Total adsorption capacity for particles and non-polar gaseous emissions using an all-in-one getter with single-layered structure, as detailed herein.

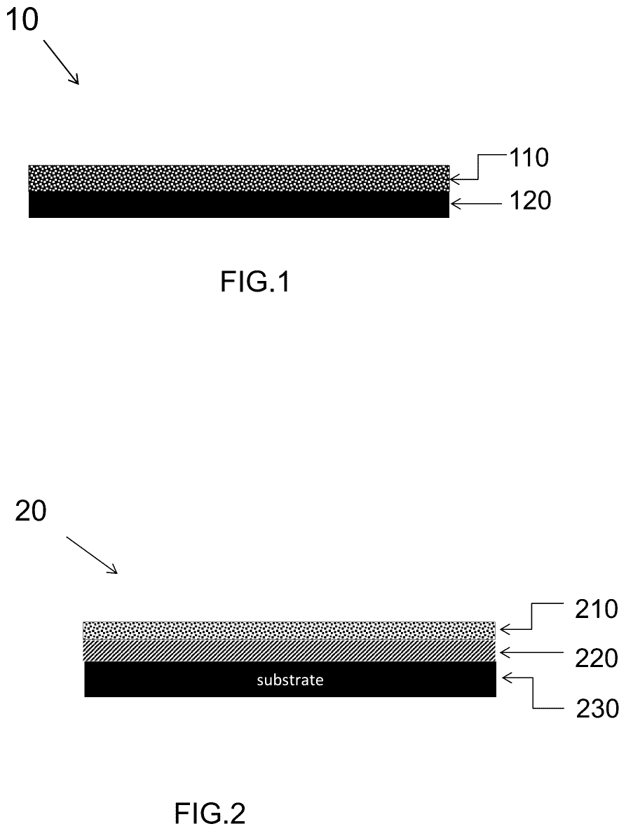

### DETAILED DESCRIPTION OF THE INVENTION

The embodiments presented in this disclosure are intended to be illustrative rather than limiting. While specific implementations are detailed, alternative designs and materials can also be employed. The structural and functional details provided serve as a guide for practitioners skilled in the art to apply and adapt the described principles. Features depicted in one figure may be combined with those in other figures to create configurations not explicitly described. Modifications and combinations consistent with the principles of this disclosure can be tailored to suit specific applications or requirements.

A multi-functional getter, based on a functional particle co-embedded hierarchical porous nanostructured polymer composite, is designed to capture both particle and gaseous emissions. This involves integrating various particle types into a polymer matrix while ensuring balanced surface energy among the particles, nanoparticles, and the polymer matrix. To effectively co-embed functional particles, the getter material's surface energy must align with the adsorbed particles to enhance compatibility and adsorption efficiency. Specific requirements include:
Hydrophilic dielectric particles: High surface energy (˜70 mJ/m²).
Hydrophobic dielectric particles: Low surface energy (<20 mJ/m²).
Electric particles: High surface energy (50-70 mJ/m²).
Magnetic particles: Low-to-moderate surface energy (15-40 mJ/m²).
Dielectric particles: Low surface energy (10-30 mJ/m²).
Fine dust: Surface energy requirements depend on dust composition:
   Hydrophilic dust (e.g., silica-based): High surface energy (40-60 mJ/m²).
   Hydrophobic dust (e.g., carbonaceous): Low surface energy (<20 mJ/m²).
Microbial contaminants: low-to-high surface energy (15-80 mJ/m²).

To design a getter assembly optimized for particle capture and gas adsorption, the functional particles are selected based on the specific requirements:
Trapping electric particles: selected from silver (Ag), barium titanate (BaTiO₃), and copper oxide (CuO).
Trapping magnetic particles: selected from ferromagnetic materials (Fe, Co, Ni) and ferrimagnetic particles (Fe₃O₄, Fe₂O₃, CoFe₂O₄).
Trapping dielectric particles and fine dust: selected from Alumina (α-Al₂O₃), silica (SiO₂), zirconia (ZrO₂), titanium dioxide (TiO₂), zinc oxide (ZnO), and silicon carbide (SiC).
Trapping microbial contaminants: selected from silver (Ag) and titanium dioxide (TiO₂), Gold (Ag), copper oxide (CuO), and zirconium oxide (ZrO).

An all-in-one getter with a single-layered structure (10) is designed to efficiently capture particulate emission while also adsorbing gaseous emissions. The polymer composite layer (110) integrates functional particles, magnetic nanoparticles, dielectric nanoparticles, and adsorptive nanoparticles like hydrophilic microporous nanomaterials, hydrophobic microporous nanomaterials, and hydrophobic mesoporous nanomaterials. These nanomaterials are co-embedded into a polymer matrix with surface energy compatibility. The substrate (120) can be chosen from metals such as Cu, Al alloys, Ti, Ni, or materials like borosilicate glass and alumina.

Another all-in-one getter features a bilayered structure (20) designed to simultaneously capture both particle and gaseous emissions. The internal layer (220) integrates electric functional particles, magnetic particles, dielectric particles, and antimicrobial particles within a polymer matrix. The outer layer (210) is dedicated to gas and organic compound adsorption and can include quaternary, ternary, or binary phases of hydrophilic and hydrophobic microporous nanomaterials, hydrophobic mesoporous nanomaterials, or hydrophobic macroporous nanomaterials. The polymer matrix might include polyvinyl alcohol (PVA) for polar gases or silicone RTV for non-polar gases. The substrate (230) can be selected from metals like Cu, Al alloys, Ti, Ni, or materials such as borosilicate glass and alumina.

A multilayered all-in-one getter integrates internal layers (310, 320, 330) for particle capture and an outer layer (340) for gaseous emission adsorption. The outer layer can be composed of a combination of quaternary, ternary, or binary phases including hydrophilic microporous, hydrophobic microporous, hydrophobic mesoporous, and/or hydrophobic macroporous nanomaterials. A hydrophilic polymer such as PVA or epoxy resin is suitable for polar gases, while a hydrophobic polymer like silicone RTV or polyimide is ideal for non-polar VOCs. The internal layers are made thicker to enhance particle capture capacity, while the outer layer is optimized to minimize gas diffusion resistance and ensure adequate adsorption capacity. The substrate (350) can be selected from metals like Cu, Al alloys, Ti, Ni, or materials such as borosilicate glass and alumina.

A single-layered all-in-one getter is a polymer composite incorporating functional particles co-embedded within a hierarchical porous polymer composite. This getter is designed to adsorb all emissions from an electronic package. A typical composition might include 15 wt % functional particles (e.g., 5 wt % electric particle, 5 wt % magnetic particle, 5 wt % dielectric particle) embedded in a quaternary polymer composite consisting of 18 wt % hydrophilic microporous nanomaterial, 18 wt % hydrophobic microporous nanomaterial, 18 wt % hydrophobic mesoporous nanomaterial, and 31 wt % polymer matrix. As illustrated in FIG. 4, this getter demonstrates the following adsorption capacities:
12-15 wt % Polar gases (e.g., H₂O, CO₂, CO, NH₃, SO₂)
8-10 wt % Non-polar gases (e.g., H₂, O₂, N₂, CH₄)
10-12 wt % Polar organic compounds (e.g., methanol, ethanol, acetone, formaldehyde)
4-6 wt % Non-polar organic compounds (e.g., toluene, benzene, xylene, hexane)
3-5 wt % Electric particle trapping
3-5 wt % Magnetic particle trapping
3-5 wt % Dielectric particles and fine dusts trapping

This all-in-one getter offers balanced performance across all particulate and gaseous emissions, irrespective of polarity, particle type, or surface energy characteristics.

As shown in FIG. 4, electric functional particles effectively capture electrically charged particles with a capacity of 3-5 wt %. Magnetic functional particles can capture magnetic particles such as ferric dust or magnetized particulates, also with a similar capacity of 3-5 wt %. Dielectric functional particles excel at trapping non-magnetic, non-charged dielectric particles and fine particulates, with a capacity of 3-5 wt %. These functional particles also weakly contribute to the adsorption of non-polar gases (e.g., H₂, O₂, N₂, CH₄), as shown in Table 1. This additional adsorption capability enhances the overall gas adsorption capacity of the polymer composite through mechanisms like physisorption and chemisorption. Notably, silver particles serve a dual purpose: they not only capture electrically charged particles but also exhibit antimicrobial properties, directly disrupting microbial cell membranes and structures. This makes silver particles particularly advantageous for medical applications.

TABLE 1
Contributions of functional particles to non-polar gases adsorption

| Particles | Hydrogen | | Oxygen | | Nitrogen | | Methane | |
|---|---|---|---|---|---|---|---|---|
| Barium Titanium | <0.5 | wt % | <0.5 | wt % | <0.5 | wt % | <0.5 | wt % |
| Iron Oxide | ~0.5 | wt % | 1.0-2.0 | wt % | ~0.5 | wt % | ~0.5 | wt % |
| Alumina | 0.5-1.0 | wt % | 1.0-2.0 | wt % | 0.3-0.5 | wt % | 0.3-0.5 | wt % |
| Silver | ~0.5 | wt % | 2.0-4.0 | wt % | ~0.5 | wt % | ~0.5 | wt % |

The all-in-one getter with a bilayered structure 20 features an internal layer designed to capture particles using a functional particle-embedded polymer composite, while the outer layer consists of a multi-phase hierarchical porous nanostructured polymer composite to efficiently adsorb all types of emissions from an electronic package. The performance of this getter can be evaluated by considering a composition that combines hydrophilic microporous nanoparticles, hydrophobic microporous nanoparticles, and mesoporous nanoparticles for broad-spectrum adsorption of particles, gases, and organic compounds. The outer layer 210 consists of hydrophilic microporous nanomaterial, which adsorbs polar gases and organic compounds, and hydrophobic microporous nanomaterial along with hydrophobic mesoporous nanomaterial for non-polar gases and organic compounds. The internal layer 220 primarily focuses on particle capture, with functional particles such as silver or barium titanate (for capturing electrically charged particles), iron oxides (for magnetic particles), and alumina (for dielectric particles and fine dust) co-embedded in a polymer matrix. This bilayered structure optimizes functionality by separating gas/organic compound capture (outer layer) from particle capture (internal layer). If silver functional particles are used, the getter can also exhibit antimicrobial properties by releasing silver ions, generating reactive oxygen species (ROS), and directly damaging microbial cell membranes and structures, making it suitable for medical applications. The substrate material 230, such as copper, aluminum alloys, nickel, titanium, alumina, or borosilicate glass, can further enhance the getter's mechanical performance.

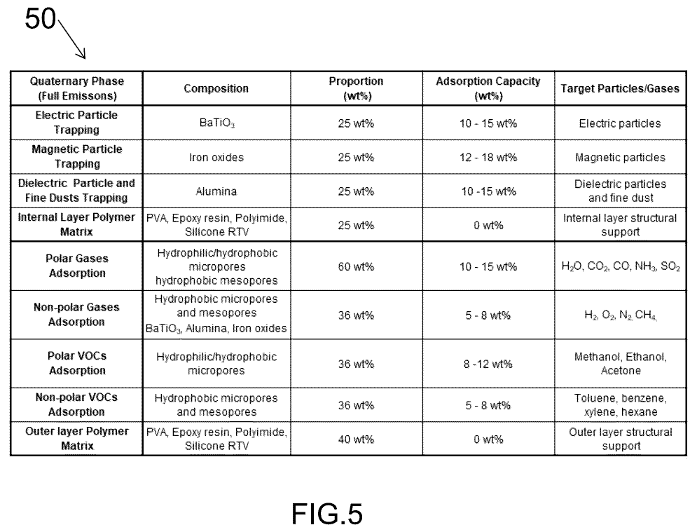

As another example, the performance of the all-in-one getter with bilayered structures can be estimated with a composition of 75 wt % functional particles (comprising 25 wt % electric functional particles, 25 wt % magnetic functional particles, and 25 wt % dielectric functional particles) co-embedded into a 25 wt % polymer matrix in the internal layer 220. The outer layer 210 is composed of 20 wt % hydrophilic microporous zeolite, 20 wt % hydrophobic microporous silicate, and 20 wt % hydrophobic mesoporous silica, all embedded in a 40 wt % polymer matrix. As illustrated in FIG. 5, this getter demonstrates the following adsorption capacities:
10-15 wt % for polar gases (e.g., H₂O, CO₂, CO, NH₃, SO₂)
5-8 wt % for non-polar gases (e.g., H₂, O₂, N₂, CH₄)
8-12 wt % for polar organic compounds (e.g., methanol, ethanol, acetone, formaldehyde)
5-8 wt % for non-polar organic compounds (e.g., toluene, benzene, xylene, hexane)
12-15 wt % for electric particle trapping
12-18 wt % for magnetic particle trapping
12-15 wt % for dielectric particle and fine dust trapping

This bilayered getter structure offers balanced performance across a wide range of emissions, regardless of the particle and gas types.

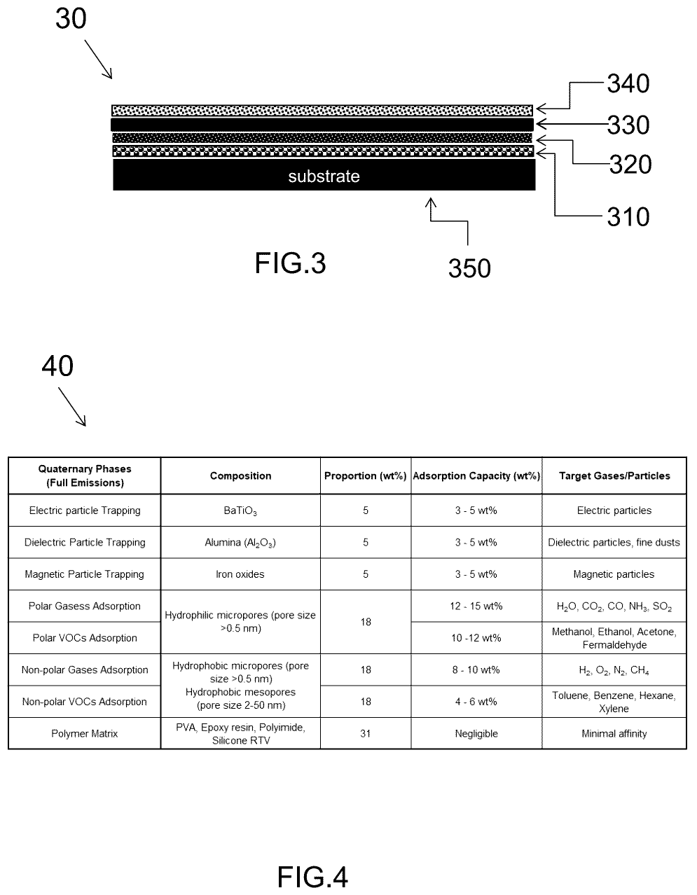

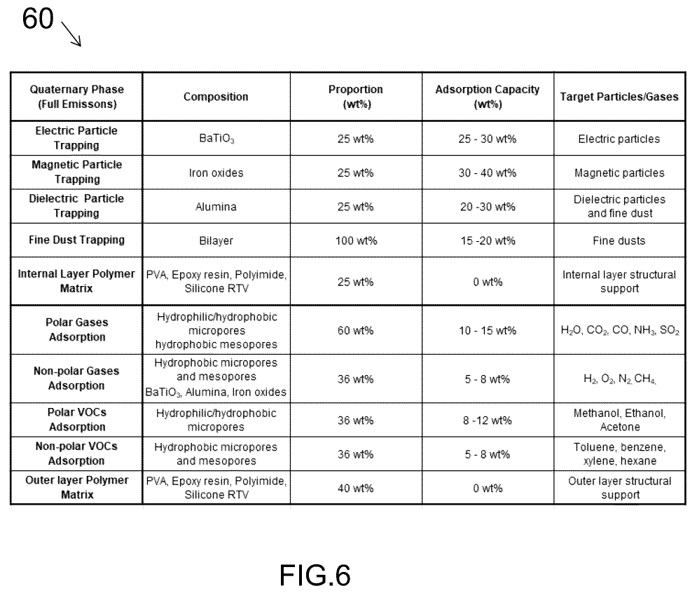

The all-in-one getter with a multilayered structure (30) separates each functional particle into distinct layers, each allocated specific functional particles. The outer layer features a multi-phase hierarchical porous nanostructured polymer composite designed to maximize particle capture capacity and the adsorption of emissions from electronic packages. FIG. 3 illustrates a getter (30) with four distinct layers: 310, 320, 330, and 340. The outer layer (340) is a quaternary composite comprising a mix of hydrophilic micropores, hydrophobic micropores, and hydrophobic mesopores. Each functional particle, including 60 wt % silver or barium titanate for electric particle trapping, 60 wt % iron oxides for magnetic particle trapping, and 60 wt % alumina for dielectric particle and fine dust trapping, is embedded in a 40 wt % polymer matrix to form the internal layers. The outer layer composition consists of 20 wt % hydrophilic microporous zeolite, 20 wt % hydrophobic microporous silicate, and 20 wt % hydrophobic mesoporous silica, all co-embedded in a 40 wt % polymer matrix. As shown in FIG. 6, this getter can adsorb similar polar gases, non-polar gases, and both polar and non-polar organic compounds as the bilayered getter structure. However, the multilayered structure offers a higher particle adsorption capacity compared to the bilayered structure.

To optimize particle adsorption in the multilayered getter (30) depicted in FIG. 3, the sequence of layers should be strategically designed to maximize the interaction and efficiency of each layer. The electric particle-embedded layer should be placed first on the substrate, as it effectively captures oppositely charged particles. The magnetic particle-embedded layer should be positioned second, as it can attract and retain particles with magnetic properties. The dielectric particle-embedded layer should be placed third to trap particles that pass through the first two layers. The outermost layer should be positioned last to provide a surface for capturing emitted particles and adsorbing outgassed substances. This layered arrangement leverages the distinct properties of each layer, enhancing the overall particle adsorption efficiency.

Each all-in-one getter, whether it's a single-layer, bilayer, or multilayer structure, offers distinct advantages for various applications. A single-layer structure is customized to address specific emissions or contaminants by adjusting the composition of adsorbents and polymers, ensuring uniform performance across the surface. The bilayer structure provides targeted functionality: an inner layer captures particles such as magnetic, electric, dielectric particles, fine dust, or microbial particles, while an outer layer focuses on capturing gases and organic compounds, offering high specificity. This dual-layer configuration effectively manages both particle and gaseous emissions while minimizing cross-contamination. For enhanced multifunctionality, a multilayered structure incorporates layers specifically optimized for different targets, such as electric particles, magnetic particles, dielectric particles, gases, and organic compounds, with each layer tailored for maximum performance. As illustrated in FIG. 4, FIG. 5, and FIG. 6, these getter structures can capture both particulate and gaseous emissions, with capacities adjustable by varying the composition ratio in the composite.

Specialized Functional Particle Getters. In specialized scenarios where gaseous emissions are not a concern, functional particles are embedded directly into a selected polymer matrix, such as PVA, polyimide, silicone RTV, epoxy resin, PC, or PTFE, to create single-function or multi-functional particle getters without gas adsorption capacity. These getters are specifically designed to capture electric particles, magnetic particles, dielectric particles, fine dust, microbial contaminants, or any combination thereof. They can be applied as a single-layer getter onto a substrate or as a free-standing film. For example, a composite consisting of 16 wt % BaTiO₃, 16 wt % silver, 16 wt % Fe₃O₄, 16 wt % alumina, and 36 wt % polymer matrix could be used. The adsorption capacity of the particle getter can be estimated based on a particle surface density of 5 m²/g. Table 2 presents a hypothetical summary of these adsorption capacities for electric, magnetic, dielectric, and fine dust particles in an electronic package.

TABLE 2
Adsorption capacity of an example particle getter without gas adsorption

| | | Adsorption | Adsorption |
|---|---|---|---|
| Particle types | Key contributor | Capacity (wt %) | capacity mg/m² |
| Electric particles | Silver, BaTiO₃ | 5-10 | 10-20 |
| Magnetic particles | Iron oxides | 20-50 | 40-100 |
| Dielectric particles | BaTiO₃ | 8-15 | 16-30 |
| Fine dust particles | Al₂O₃, polymer | 1-3 | 2-6 |

Using a PVA polymer matrix enhances adhesion for hydrophilic particles, slightly improving fine dust capture. The hydrophobic nature of the silicone RTV polymer matrix limits interactions with certain particles but increases durability. Meanwhile, the polyimide matrix offers excellent thermal resistance, maintaining functionality at elevated temperatures. The adsorption capacity of particle getters is proportional to the getter's surface area, with a larger surface area providing more sites for particle capture. A particle getter can be made from functional particles embedded in a silicone polymer, as in the example above. Comparing this with a particle getter made from functional particles embedded in a hierarchical porous polymer composite, silicone polymers typically have limited inherent porosity. This greatly reduces their efficiency in capturing very fine particles or gases compared to hierarchical porous structures. Furthermore, the lack of inherent porosity results in a lower surface area available for adsorption, impacting overall capture efficiency. Nevertheless, such a simple particle getter could be a suitable choice for electronic packages with fewer particulate and gaseous emissions.

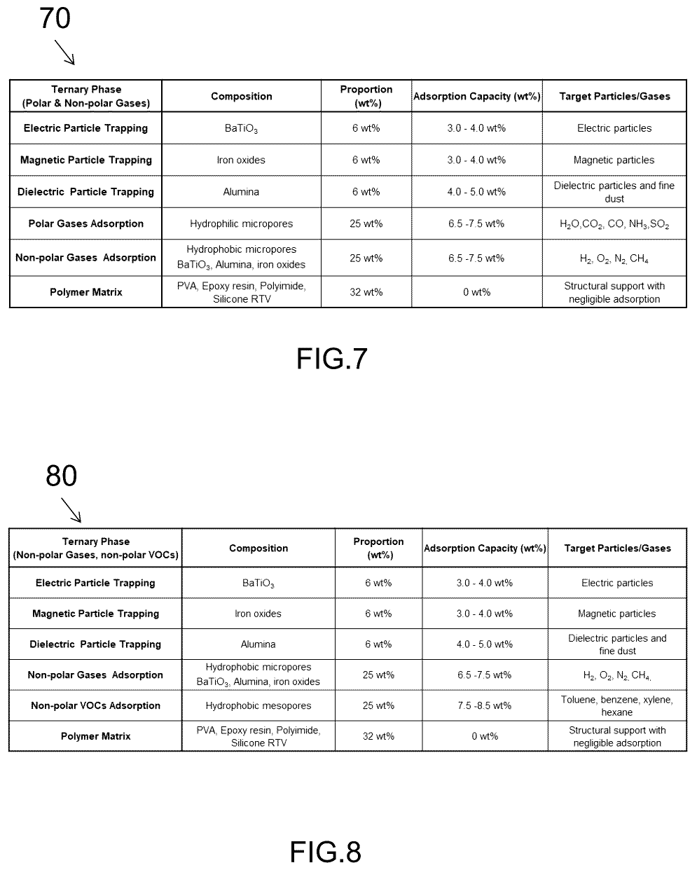

All-in-One Getters with Specific Functions. Due to the varied emissions from different packaging materials, a getter may need to target specific contaminants such as polar gases, non-polar gases, or organic compounds. An all-in-one getter can be customized for these specific needs. FIG. 7 illustrates a customized all-in-one getter designed to capture particles, polar gases, and non-polar gases. This single-layer structure features a particle-co-embedded ternary hierarchical porous nanostructured polymer composite. It consists of 18 wt % functional particles (e.g., 6 wt % electric functional particles, 6 wt % magnetic functional particles, and 6 wt % dielectric functional particles) integrated into a ternary polymer composite that includes 25 wt % hydrophilic microporous nanomaterial, 25 wt % hydrophobic microporous nanomaterial, and 32 wt % polymer. The adsorption capacities are as follows:
Electric particles trapping: 3.0-4.0 wt %
Magnetic particles trapping: 3.0-4.0 wt %
Dielectric particles and fine dust trapping: 4.0-5.0 wt %
Polar gases (e.g., H₂O, CO₂, CO, SO₂, NH₃): 6.5-7.5 wt %
Non-polar gases (e.g., H₂, CH₄, N₂, O₂): 6.5-7.5 wt %

The total adsorption capacity for particles is approximately 10-13 wt % and 13-15 wt % for gas adsorption. This configuration is optimized for capturing electric, magnetic, and dielectric particles, along with a balanced adsorption of polar and non-polar gases. However, it does not specifically target organic compounds.

Customized All-in-One Getters for Non-Polar Gases and Organic Compounds. In scenarios requiring specific functions for adsorbing non-polar gases and non-polar organic compounds, a getter can be customized to meet these needs. As shown in FIG. 8, a specialized all-in-one multi-functional getter is designed to capture particles, non-polar gases, and non-polar organic compounds. This getter features a functional particle-doped ternary hierarchical porous nanostructured polymer composite, consisting of 18 wt % functional particles (e.g., 6 wt % silver or BaTiO₃ for electric trapping, 6 wt % iron oxides for magnetic particle trapping, and 6 wt % alumina for dielectric particle and fine dust trapping) incorporated into a ternary polymer composite. This composite includes 25 wt % hydrophobic microporous silicates, 25 wt % hydrophobic mesoporous silica, and 32 wt % polymer. The adsorption capacities are as follows:
Electric particle trapping: 3.0-4.0 wt %
Magnetic particle trapping: 3.0-4.0 wt %
Dielectric particles and fine dust trapping: 4.0-5.0 wt %
Non-polar gases (e.g., H₂, O₂, N₂, CH₄): 6.5-7.5 wt %
Non-polar volatile organic compounds (e.g., toluene, benzene, etc.): 7.5-8.5 wt %

The total adsorption capacity for particles is approximately 10-13 wt %, and 14-16 wt % for non-polar gases and organic compounds. This design excels in capturing electric, magnetic, and dielectric particles, as well as non-polar gases and organic compounds. It is ideal for environments where the removal of non-polar gases and organic compounds is prioritized over polar gases or moisture. The use of low-surface-energy hydrophobic microporous and mesoporous nanoparticles enhances the adsorption of non-polar gases (pore size <1 nm) and non-polar organic compounds (pore size up to 50 nm).

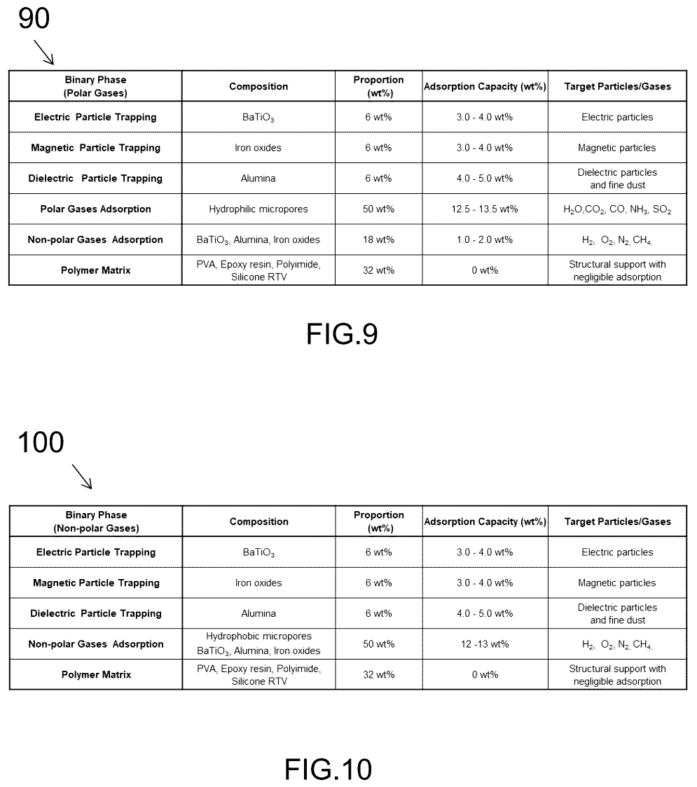

Customized All-in-One Getters for Specific Contaminants. Given the diverse emissions from various packaging materials, a getter may need to target specific contaminants such as particles and polar gases (e.g., H₂, O₂). An all-in-one getter can be customized to meet these specific needs. FIG. 9 illustrates a customized all-in-one getter designed to capture both particles and polar gases. This structure integrates 18 wt % functional particles, including 6 wt % silver or BaTiO₃ for electric particle trapping, 6 wt % iron oxides for magnetic particle trapping, and 6 wt % alumina for dielectric particle and fine dust trapping. These functional particles are embedded in a binary polymer composite consisting of 50 wt % hydrophilic microporous zeolite and 32 wt % polymer. The adsorption capacities are as follows:
Electric particle trapping: 3.0-4.0 wt %
Magnetic particle trapping: 3.0-4.0 wt %
Dielectric particles and fine dust trapping: 4.0-5.0 wt %
Polar gases (H₂O, CO₂, CO, NH₃, and SO₂): 12.5-13.5 wt %

The composite offers a combined adsorption capacity of approximately 22-26 wt %, optimized for environments where the removal of polar gases is essential, while also providing effective particle trapping capabilities. This design highlights the use of high-surface-energy hydrophilic microporous nanoparticles to adsorb polar gases with a pore size of less than 1 nm.

Customized All-in-One Getters for Particles and Non-Polar Gases. Given the diverse emissions from various packaging materials, a getter may need to focus on particles and non-polar gases (e.g., H₂, O₂, N₂, CH₄). Hydrogen (H₂) and oxygen (O₂) can pose significant risks of device failure through hydride formation and oxidation-induced corrosion. An all-in-one getter can be specifically tailored to address these needs, as illustrated in the following example. FIG. 10 shows a customized all-in-one getter designed to capture both particles and non-polar gases. This getter comprises 18 wt % functional particles, including 6 wt % silver or BaTiO₃ for electric particle trapping, 6 wt % iron oxides for magnetic particle trapping, and 6 wt % alumina for dielectric particle and fine dust trapping. These particles are integrated into a binary polymer composite consisting of 50 wt % hydrophobic microporous silicate and 32 wt % polymer. The adsorption capacities are as follows:
Electric particle trapping: 3.0-4.0 wt %
Magnetic particle trapping: 3.0-4.0 wt %
Dielectric particles and fine dust trapping: 4.0-5.0 wt %
Non-polar gases (H₂, O₂, N₂, and CH₄): 12.0-13.0 wt %

The total estimated adsorption capacity is approximately 22-26 wt %, excluding organic compound adsorption. This composition emphasizes the importance of integrating low-surface-energy, hydrophobic microporous nanoparticles with a pore size of less than 1 nm to efficiently adsorb non-polar gases.

In certain situations, a getter must target particles, polar gases (e.g., H₂O, CO₂, CO), and polar organic compounds (e.g., methanol, ethanol, acetone). To address these needs, an all-in-one getter can be specifically designed as follows: This getter comprises 18 wt % functional particles, including 6 wt % silver or BaTiO₃ for electric particle trapping, 6 wt % iron oxides for magnetic particle trapping, and 6 wt % alumina for dielectric particle and fine dust trapping. These particles are embedded in a binary polymer composite made up of 50 wt % hydrophilic microporous 13X zeolite and 32 wt % polymer. The estimated adsorption capacities for different targets are:
Electric particle trapping: 3.0-4.0 wt %
Magnetic particle trapping: 3.0-4.0 wt %
Dielectric particles and fine dust trapping: 4.0-5.0 wt %
Polar gases (e.g., H₂O, CO₂, CO, SO₂, NH₃): 15.0-20.0 wt %
Polar organic compounds (e.g., methanol, ethanol, acetone): 8.0-12.0 wt %

The total estimated adsorption capacity is approximately 22-26 wt %, covering particles, polar gases, and polar organic compounds. This design highlights the importance of integrating high-surface-energy hydrophilic 13X zeolite microporous nanoparticles, with pore sizes of less than or equal to 1 nm, to effectively adsorb polar gases and organic compounds.

The estimate of the adsorption capacities of a polymer composite-based getter depends on several factors. The first step is to determine the individual adsorption capacities of each component for the target gases and organic compounds. A weighted average approach is used to combine the adsorption capacities of each component based on their respective weight fractions, as described by the following equation:

$$Adsorption ( compoiste ) = {\sum }_{i} f ( i ) * A ( i ) , i = 1 to n , \qquad ( 1 )$$

In this equation, n represents the maximum number of phases (1-5), and f (i) and A (i) are the weight fraction and adsorption capacity of each phase material for a specific gas or organic compounds. For polar gases, 13X zeolite exhibits typical adsorption capacities of 25 wt % for moisture, 20-25 wt % for carbon dioxide, 1-3 wt % for carbon monoxide, 15-20 wt % for ammonia, and 20-30 wt % for sulfur dioxide. In contrast, its adsorption capacities for non-polar gases are significantly lower, with 0.1-0.5 wt % for hydrogen, 0.5-1.0 wt % for oxygen and nitrogen, and 2-5 wt % for methane. Adsorption capacities can be enhanced under higher pressures or lower temperatures due to increased physisorption. For example, methane adsorption may improve considerably at elevated pressures. While 13X zeolite has limited capacity for non-polar gases, it demonstrates higher selectivity for polarizable or quadrupolar molecules, such as methane (CH₄). This equation could give an approximate adsorption capacity from a polymer composite composition for getter design optimization.

Further Investigation for Getter Development. Further research is needed to develop getters suitable for a wide range of industrial applications in emission control. Hydrophilic zeolites show minimal adsorption for gases like hydrogen (H₂), oxygen (O₂), ethanol, and benzene. In contrast, hydrophobic microporous zeolites can adsorb up to 0.5 wt % H₂, 0.7 wt % O₂, 5 wt % ethanol, and 10 wt % benzene at room temperature, particularly with larger zeolite particles. A 13X zeolite predominantly adsorbs polar gases and organic compounds, such as H₂O, CO₂, NH₃, and methanol. Hydrophobic microporous materials excel at adsorbing non-polar gases and hydrocarbons, including CH₄, benzene, and toluene. Hydrophobic mesoporous and macroporous silicas offer versatility, adsorbing both polar and non-polar gases due to their large surface area (˜1000 m²/cm³) and pore size of up to 300 nm, though their adsorption capacity is moderate compared to zeolites.

While the polymer matrix typically contributes negligibly to adsorption compared to functional particles, it can indirectly affect performance. Poor dispersion of the polymer can block access to the adsorbent surface, reducing efficiency. Conversely, polymers with mild adsorption properties, such as low-surface-energy silicone RTV or PTFE, may enhance adsorption for specific organic compounds. Unless the polymer matrix is known to function as an active adsorbent, its contribution can generally be considered negligible for simplicity.

Estimating Adsorption Capacity of a Multi-Phase Composite Getter. The adsorption capacity of a multi-phase composite getter can be estimated with the following example. Suppose hydrophilic 13X zeolite adsorbs 15 wt % water and 12 wt % CO₂, hydrophobic microporous silicate adsorbs 10 wt % CH₄ and 8 wt % benzene, and hydrophobic mesoporous silica adsorbs 5 wt % water and 5 wt % benzene. If each phase constitutes 25 wt % of the polymer composite, the adsorption capacities for all target gases and organic compounds are summarized in Table 3. These values represent nominal adsorption capacities; actual performance may vary depending on factors such as pressure, temperature, and exposure time. Adding functional particles to the composite introduces further complexity, as these particles contribute additional adsorption capacity, albeit modestly. Therefore, the calculated capacities should be regarded as approximate and used for reference purposes only.

TABLE 3
Method for adsorption capacity analysis from multi-phase composite

| | | 25 wt % | 25 wt % | 25 wt % | |
|---|---|---|---|---|---|
| | | Hydrophilic | Hydrophobic | Hydro- | Total |
| | | micro- | micro- | phobic | Adsorp- |
| | | porous | porous | mesoporous | tion |
| | | zeolite | silicate | silica | Capacity |
| Gases | Polarity | (wt %) | (wt %) | (wt %) | (wt %) |
| Moisture | Polar | 15 | 0 | 5 | 6.25 |
| (H₂O) | gas | | | | |
| Carbon | Polar | 12 | 0 | 0 | 3 |
| dioxide | gas | | | | |
| (CO₂) | | | | | |
| Methane | Non- | 0 | 10 | 0 | 2.5 |
| (CH₄) | polar | | | | |
| | gas | | | | |
| Benzene | Non- | 0 | 8 | 5 | 3.25 |
| (C₆H₆) | polar | | | | |
| | VOC | | | | |

Polymer composite fabrication can utilize various film-coating techniques, such as doctor blade coating, dipping, and spraying. However, 3D printing is often favored due to its precision, layer-by-layer deposition process, which enables the creation of complex, three-dimensional structures with software-driven accuracy. This technique allows for the development of intricate geometries, including porous and multi-layered designs that optimize hierarchical porous nanostructures for adsorption. It is especially advantageous for crafting application-specific structures tailored to unique adsorption requirements. Furthermore, 3D printing supports the integration of hierarchical porosity (micro-, meso-, and macropores), improving getter efficiency while enabling the incorporation of diverse functional particles and nanoparticles into the polymer matrix. This approach is crucial for producing high-performance all-in-one getters with customized designs suited for specialized or challenging emission control applications.

As an example to fabricate a polymer getter using 3D Printing with a polymer slurry comprising 20 wt % hydrophilic microporous material, 20 wt % hydrophobic microporous material, 20 wt % Hydrophobic mesoporous material, 20 wt % hydrophobic macroporous material, and 20 wt % polymer Matrix.

### 1. Material Preparation:

Powder Mixing: Accurately weigh hydrophilic microporous material, hydrophobic microporous material, hydrophobic mesoporous, and hydrophobic macroporous powders. Use a mechanical mixer to homogenize the powders to ensure uniform distribution.

### 2. Polymer Matrix Preparation:

For PVA: Dissolve PVA in deionized water by heating (60-90° C.) while stirring until a viscous solution forms.
For Polyimide: Dissolve polyimide precursor in a compatible solvent like NMP or DMF.
For Silicone RTV: Use as-is or dilute with a suitable solvent to adjust viscosity.
For Epoxy Resin: Mix resin with its curing agent as specified by the manufacturer.

### 3. Slurry Formation:

Gradually add the powder mixture into the polymer solution while stirring to create homogenous slurry.
Adjust the viscosity by adding solvent (if needed) to ensure the slurry viscosity is suitable for 3D printing.

3D Printing Process for fabricating an all-in-one getter:
Use an extrusion-based 3D printer (such as FDM or DIW) equipped with a nozzle suitable for viscous slurries. Load the polymer slurry into the printer's extrusion system.
Prepare a substrate (e.g., glass or metal plate) for the polymer composite printing. Optionally, apply a release agent (such as PVA or silicone mold release), to the substrate to ease removal of the printed getter structure.
Design the desired geometry using CAD software (e.g., porous, layered, or multi-functional structures). Set the printer to deposit the slurry layer-by-layer according to the designed pattern. Ensure consistent extrusion pressure and layer thickness to achieve uniform porosity and structure.
Adjust the print speed, extrusion rate, and infill pattern to control porosity (micro-, meso-, and macropores). Use specific nozzle movements to integrate interconnected pores and maximize surface area.

Post-Processing for printed getter film.
Allow the printed structure to air dry or use a controlled drying oven to remove solvents at low temperatures (30-60° C.) for preventing cracks or deformation.
For PVA: Further drying at slightly elevated temperatures (80-100° C.).
For Polyimide: Cure the printed part in a stepwise process to remove solvent and imidize (e.g., heating to 300° C. in inert gas).
For Silicone RTV: Allow curing at room temperature or accelerate by heating (e.g., 60-80° C.).
For Epoxy Resin: Follow the curing cycle as specified (e.g., 60-120° C. for a few hours).

When fabricating a getter film using 3D printing, adjusting the viscosity of the composite slurry is critical to achieving optimal results. Lower viscosities (˜1 Pa·s) allow for easier flow but may lack the structural stability needed for intricate designs. Conversely, higher viscosities (˜10² Pa·s) provide greater support for self-standing, high-precision structures but require increased extrusion force. The viscosity of the polymer composite slurry is influenced by the powder material content, while the solvent quantity can be adjusted to achieve the desired flowability. Notably, polymers such as PVA, silicone RTV, polyimide, and epoxy exhibit varying intrinsic viscosities, which must be considered when formulating the slurry.

The fabrication of a getter using a 3D printing method typically involves nozzle diameters ranging from 100 μm to 400 μm to achieve high-resolution structures. For slurries containing particles with sizes between 10-20 μm, a nozzle diameter of at least 200 μm is preferred to minimize clogging. Proper dispersion and low viscosity of the slurry are crucial to ensure smooth flow through the nozzle. High-viscosity slurries can lead to clogging or require excessive extrusion pressure, complicating the process. For instance, delivering a polymer slurry with a viscosity of 10 Pa·s and a density of 1.2 g/cm³ through a 200 μm nozzle to cover a 10 cm² area in 1 minute, may demand approximately 500 psi of extrusion pressure at a flow rate of 1.4×10⁻² cm³/s and a nozzle length of 1 mm. Additionally, a controlled substrate heating between layers can aid in solvent evaporation, preventing cracks in the printed film and enabling precise control over the final getter thickness.

What is claimed is:

1. An all-in-one getter assembly for capturing both particulate and gaseous emissions from an electronics package, device, or module, comprising:
A multi-phase hierarchical porous nanostructured polymer composite;
Functional particles; and
A substrate.

2. The all-in-one getter assembly according to claim 1, wherein the multi-phase hierarchical porous nanostructured polymer composite comprises:
Microporous nanomaterials;
Mesoporous nanomaterials;
Macroporous nanomaterials, and
A polymer matrix.

3. The all-in-one getter assembly according to claim 2, wherein the microporous nanomaterials include:
Hydrophilic microporous nanomaterials selected from one or more of 3A, 4A, 5A, 13X zeolites, zeolite X, zeolite A, and natural zeolites; and
Hydrophobic microporous nanomaterials selected from one or more of silicalite-1, silicalite-2, ZSM-5, Beta-zeolite, and zeolite Y.

4. The all-in-one getter assembly according to claim 2, wherein the mesoporous nanomaterials include:
Hydrophilic mesoporous nanomaterials selected from one or more of silica aerogel, SBA-15, MCM-41, and alumina aerogel, and hydrophilic; and
Hydrophobic mesoporous nanomaterials selected from one or more of silica aerogel, fluorosilica aerogel, alkylsilica aerogels, polymeric silica aerogels, and organosilica materials.

5. The all-in-one getter assembly according to claim 2, wherein the macroporous nanomaterials include:
Hydrophilic macroporous nanomaterials selected from macroporous silica, alumina, ceramics, and macroporous zeolites; and
Hydrophobic macroporous nanomaterials selected from similar hydrophobic aerogel materials.

6. The all-in-one getter assembly according to claim 2, wherein the multi-phase hierarchical porous nanostructured polymer composite comprises a polymer matrix selected from one or more of:
Polyvinyl alcohol (35-55 mJ/m² surface energy);
Epoxy resin (40-50 mJ/m²);
Polycarbonate (40-50 mJ/m²);
Silicone RTV (20-25 mJ/m²);
Polytetrafluoroethylene (18-30 mJ/m²); and
Polyimide (35-40 mJ/m²),
providing structural integrity, compatibility, and thermal stability.

7. The all-in-one getter assembly according to claim 1, wherein the functional particles include:
Electric functional particles selected from one or more of barium titanate, silver, and copper oxide;
Magnetic functional particles selected from one or more of iron oxides, cobalt ferrite, and nickel oxide;
Dielectric functional particles selected from one or more of alumina, silica, zirconia, titanium dioxide, zinc oxide, and silicon carbide; and
Microbial contaminants selected from Ag, TiO₂, ZrO, Au, and CuO.

8. The all-in-one getter assembly according to claim 1, wherein each type of functional particle is optimized to capture at least one specific type of emitted particle, collectively enabling the getter assembly to address a wide range of particulate emission from electronics packages, devices, or modules.

9. The all-in-one getter assembly according to claim 1, wherein the substrate is selected from metals such as copper, aluminum-alloy, titanium, and nickel, or non-metallic materials such as borosilicate glass and alumina.

10. The all-in-one getter assembly according to claim 1, wherein the multi-phase hierarchical porous nanostructured polymer composite is tailored for adsorbing polar and non-polar gases as well as organic compounds, with limited but complementary particle capture capacity.

11. The all-in-one getter assembly according to claim 1, wherein the functional particle co-embedded multi-phase hierarchical porous nanostructured polymer composite is fabricated using a 3D printing process with a nozzle diameter ranging from 0.1 mm to 0.4 mm, with a preferred diameter of at least 0.2 mm to minimize clogging.

12. An all-in-one getter structure for capturing specific particulate and gaseous emissions from an electronics package, device, or module, comprising:
A single-layer structure,
A bilayer structure, and
A multilayer structure.

13. The all-in-one getter structure according to claim 12, wherein the layered structures printed onto a substrate comprise:
At least one phase of nanomaterials;
At least two phases of nanomaterials; or
At least three phases of nanomaterials.

14. The all-in-one getter structure according to claim 12, wherein the layered structures printed onto a substrate include:
At least one type of functional particles;
At least two types of functional particles; or
At least three types of functional particles.

15. The all-in-one getter structure according to claim 12, wherein the single-layer getter structure comprises functional particles co-embedded within a multi-phase hierarchical porous nanostructured polymer composite, specifically designed for low-level outgassed particulate and gaseous emission control.

16. The all-in-one getter structure according to claim 12, wherein the bilayer structure comprises:
A top thin layer of a multi-phase polymer composite, and
A middle layer of functional particles embedded polymer layer, printed onto a substrate to form a bilayer getter structure specifically for medium-level particulate and gaseous emission control.

17. The all-in-one getter structure according to claim 12, wherein the multilayer structure comprises:
An outer layer of a multi-phase polymer composite,
A layer of dielectric functional particles embedded in a polymer layer,
A layer of magnetic functional particles embedded in a polymer layer, and
A layer of electric functional particles embedded in a polymer layer, printed onto a substrate to form a multilayer getter structure specifically for high-level particle and gaseous emission control.

18. The all-in-one getter structure according to claim 12, wherein the functional getter comprises:
Hydrophilic microporous nanoparticles with a pore size from 0.3 to 1 nm and a surface energy of 50-70 mJ/m², and
Functional particles capable of trapping electric, magnetic, dielectric, and fine dust particles with a surface energy of 10-70 mJ/m²,
printed onto a substrate to specifically adsorb particle and polar gaseous emissions.

19. The all-in-one getter structure according to claim 12, wherein the specific functional getter comprises:
Hydrophobic microporous nanoparticles with a pore size of 0.3 to 1 nm and a surface energy of 30-50 mJ/m²,
Hydrophobic mesoporous nanoparticles with a pore size of 2 to 50 nm and a surface energy of 30-70 mJ/m²,
Hydrophobic macroporous nanoparticles with a pore size up to 300 nm and a surface energy of 30-80 mJ/m², and
Functional particles capable of trapping electric, magnetic, dielectric, and fine dust particles with a surface energy of 10-70 mJ/m²,
printed onto a substrate to capture a broad range of particles, non-polar gases, and non-polar organic compounds.

20. The all-in-one getter structure according to claim 12, wherein the specific functional getter comprises:
Electric trapping particles with a surface energy of 30-70 mJ/m²,
Magnetic trapping particles with a surface energy of 15-40 mJ/m²,
Dielectric and fine dust trapping particles with a surface energy of 30-50 mJ/m²,
Anti-microbial particles with a surface energy of 30-70 mJ/m², and
A polymer matrix with surface energy closely matched to the functional particles, selected from epoxy resin (40-50 mJ/m²), polycarbonate (40-50 mJ/m²), silicone RTV (20-25 mJ/m²), polytetrafluoroethylene (18-30 mJ/m²), and polyimide (35-40 mJ/m²),
printed onto a substrate for effective particle capture and weak gas adsorption.
